(19) United States
(12) Patent Application Publication
(10) Pub. No.: US 2024/0380231 A1
(43) Pub. Date: Nov. 14, 2024

(54) ADJUSTABLE BATTERY CHARGER

(71) Applicant: CPS Technology Holdings LLC, New York, NY (US)

(72) Inventor: James C. DOUGLASS, Newport Beach, CA (US)

(21) Appl. No.: 18/690,046

(22) PCT Filed: Sep. 9, 2022
(86) PCT No.: PCT/US2022/043006

§ 371 Date: Mar. 7, 2024

Related U.S. Application Data
(60) Provisional application No. 63/242,942, filed on Sep. 10, 2021.

(51) Int. Cl. H02J 7/00

(52) U.S. Cl. CPC H02J 7/00712; H02J 7/00036; H02J 7/0049; H02J 7/0071

(57) ABSTRACT

A charger configured for charging a battery is described. The charger is removably connectable to the battery and comprises an actuator, a power supply, and processing circuitry in communication with the actuator and the power supply. The actuator is configured to request a switch between a first charge mode and a second charge mode to be performed. The processing circuitry is configured to select one of the first charging mode and the second charging mode based at least in part on whether the switch has been requested, where the selected first charging mode triggers the power supply to charge the battery up to a first SOC threshold, and the selected second charging mode triggers the power supply to charge the battery up to a second SOC threshold. The power supply is configured to charge the battery using one of the first charging mode and the second charging mode.

### TECHNICAL FIELD

This disclosure relates to a method, apparatus, and system for battery charging.

### BACKGROUND

Motor-powered and/or electrically powered vehicles tend to rely on using one or more battery systems for providing a starting power and/or at least a portion of a motion power for the vehicle. Such vehicles may include one or more of an air- or watercraft, a rail-guided vehicle, a street vehicle, etc., where a street vehicle may refer to, for example, one or more of cars, trucks, buses, recreational vehicles, etc.

In vehicles, different types of batteries are used, such as traction batteries (for electric or hybrid electric vehicles) and starter batteries. In automotive applications, for example, a starter battery is used for providing the necessary energy/power required for starting a vehicle where a traction battery may generally refer to a battery or energy storage module, which provides motive power to the vehicle, for example.

Conventionally, lead-acid batteries are used as starter batteries for vehicles. However, lead-acid batteries are heavy due to their low energy densities. In contrast to heavy lead-acid batteries, lithium-ion energy storage modules provide high energy densities. In addition, lithium-ion energy storage modules have, for example, a longer service life, less self-discharge, higher energy density, lower weight, improved rapid charging capability and shorter maintenance intervals than conventional lead-acid batteries. However, the lithium-ion chemistry has different needs and requirements as the conventional lead-acid battery.

As battery technology evolves, the demand for improved power sources such as energy storage modules (e.g., batteries, battery cells, etc.) for vehicles continues to grow. For example, lithium-ion batteries/battery cells tend to be very susceptible to heating and/or overheating, which may negatively affect components of the energy storage module. Also, lithium-ion batteries or battery cells tend to be very sensitive with respect to overcharging and deep-discharging of the respective cells or battery, which could negatively affect battery life.

In other words, existing battery-based systems lack battery charging processes and/or components that adequately protect the battery components (such as when being charged) and/or help promote longer battery life and/or improve battery/battery system operational characteristics.

### SUMMARY

Some embodiments advantageously provide a method, device, and system for battery charging, e.g., using one or more charging modes. In one embodiment, an adjustable battery charger is described. The battery charger may dynamically adjust/determine/select one or more charging modes. In an embodiment, one charging mode may be used to charge the battery to a state of charge that is less than a threshold, e.g., less than 100%, such as to promote longer battery life. Another charging mode may be used to charge the battery to another threshold, e.g., 100%, such as to provide longer range when the battery is used by an electric vehicle.

According to one aspect, a charger configured for charging a battery is described. The charger is removably connectable to the battery and comprises an actuator, a power supply, and processing circuitry in communication with the actuator and the power supply. The actuator is configured to request a switch between a first charge mode and a second charge mode to be performed. The processing circuitry is configured to select one of the first charging mode and the second charging mode based at least in part on whether the switch has been requested. The selected first charging mode triggers the power supply to charge the battery up to a first SOC threshold. The selected second charging mode triggers the power supply to charge the battery up to a second SOC threshold. The power supply is electrically removably connectable to the battery and configured to charge the battery using one of the selected first charging mode and the selected second charging mode.

According to another aspect, a method in a charger configured for charging a battery is described. The charger is removably connectable to the battery. The method comprises requesting a switch between a first charge mode and a second charge mode to be performed; selecting one of the first charging mode and the second charging mode based at least in part on whether the switch has been requested, where the selected first charging mode triggers charging of the battery up to a first SOC threshold, and the selected second charging mode triggering the charging of the battery up to a second SOC threshold; and charging the battery using one of the selected first charging mode and the selected second charging mode.

According to an aspect, a system comprises a battery including a first terminal and as second terminal; and a charger that is configured for charging the battery and removably connectable to the battery. The charger includes a actuator, a power supply, and processing circuitry in communication with the actuator and the power supply. The actuator is configured to request a switch between a first charge mode and a second charge mode to be performed. The processing circuitry is configured to select one of the first charging mode and the second charging mode based at least in part on whether the switch has been requested, where the selected first charging mode triggers the power supply to charge the battery up to a first SOC threshold, and the selected second charging mode triggers the power supply to charge the battery up to a second SOC threshold. The power supply is electrically and removably connectable to the first and second terminals of the battery and configured to charge the battery using one of the selected first charging mode and the selected second charging mode.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a diagram of an example system according to principles disclosed herein;

FIG. 2 shows an example battery constructed in accordance with the principles of the present disclosure;

FIG. 3 is a block diagram of some entities in the system according to some embodiments of the present disclosure;

FIG. 4 is a flowchart of an example process in a charger according to some embodiments of the present disclosure; and

FIG. 5 is a flowchart of another example process in a charger according to some embodiments of the present disclosure;

FIG. 6 shows an example charger removably connected to a battery and/or battery management system (BMS) according to some embodiments of the present disclosure.

### DETAILED DESCRIPTION

Before describing in detail exemplary embodiments, it is noted that the embodiments reside primarily in combinations of apparatus components and processing steps related to battery system management. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments, the term “parameter” refers to any parameter that may be measured/determined such as voltage, current, temperature, pressure, state of charge. The parameter may be associated with a battery, battery component, vehicle (or any other system), load associated with the battery, etc. A parameter threshold may refer to a threshold associated with a parameter.

A charging mode may refer to one or more modes of charging a battery (and/or associated vehicle/system). The charging mode may be based on one parameter such state of charge of the battery. Further, a charging mode may refer to one or more charging modes such as a first charging mode and a second charging mode.

A control signal may refer to any signal (and/or data, information, etc.) that triggers at least one action and/or triggers a component to perform on action such as determine a charging mode, switch a charging mode, initiate/terminate/maintain a charging mode.

In some embodiments, the term actuator is used, which may comprise a button, a switch (e.g., proximity switch, capacitance switch, membrane switch, etc.), a selector, etc. The actuator may be configured to have one or more selectable states, which may be transmitted, e.g., to other devices, hardware such as processing circuitry, communication interfaces, etc. The actuator may also be configured to receive signal/data from other devices such as control signals. The actuator may be depressible, displayable on a display that may be configured to accept user input, removably connected (e.g., removable for remote control) to a component such as a charger, fixed to the component, etc.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

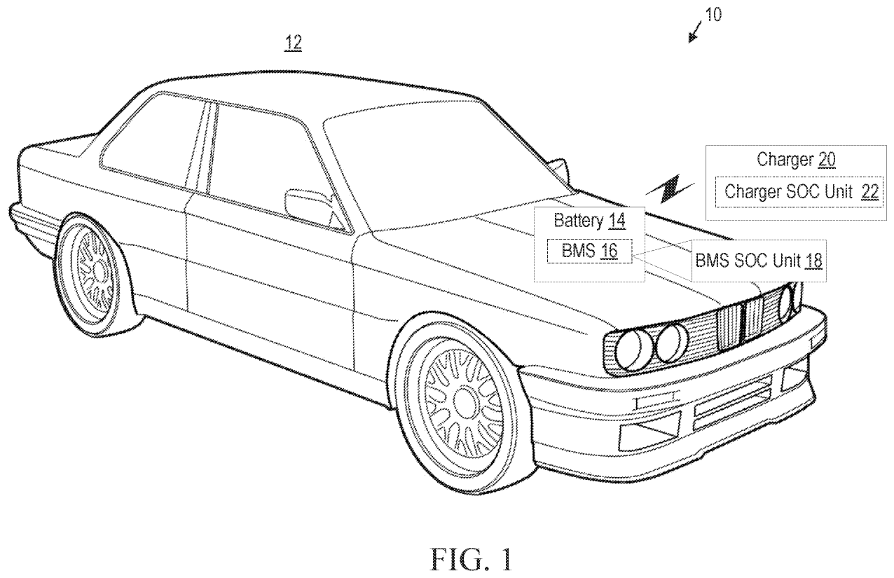

Referring to the drawing figures, in which like elements are referred to by like reference numerals, there is shown in FIG. 1 a diagram of a system 10, according to an embodiment, which comprises one or more vehicles 12 such as a motor-powered and/or electrically powered vehicle. The vehicle 12 comprises battery 14 for powering at least one functions of vehicle 12. Battery 14 may be a lithium-ion based battery that includes one or more energy storage modules. Although a lithium-ion based battery has been described, the teachings described herein are equally applicable to other battery types, such as, for example, lead-acid batteries. Battery 14 includes battery management system (BMS) 16 that is configured to perform one or more battery management functions. In some embodiments, the BMS 16 may measure/determine certain battery parameters, e.g., state of charge (SOC), voltage, etc., and transmit/receive data (and/or signals such as control signals) to/from another system/device.

A BMS 16 may be configured to include a BMS SOC unit 18 that is configured to perform any step and/or task and/or process and/or method and/or feature described in the present disclosure, e.g., to perform one or more charging functions such as with respect to performing one or more action associated with one or more charging modes, providing information associated with a parameter such as SOC usable, e.g., by a charger, for charging up to a dynamically determined SOC level or threshold, etc.

Charger 20 may be a separate device from (or comprised in) vehicle 12 and/or battery 14 and/or BMS 16 where charger 20 is configured to charge battery 14 based on at least one criterion/parameter, as described herein. Charger 20 may be removably connectable to the battery 14 (e.g., and/or any other component of system 10 such as vehicle 12 to connect to the battery 14). One or more entities in vehicle 12 may be located/positioned outside vehicle 12 such as in a charging station or other type of station.

Charger 20 is configured to include a charger SOC unit 22 that is configured to perform any step and/or task and/or process and/or method and/or feature described in the present disclosure, e.g., to perform one or more charging functions such as for charging up to a dynamically determined SOC level or threshold, etc.

It is contemplated that one or more entities in battery 14 are in communication with each other via one or more of wireless communication, power communication, wired communication, etc. Further, while it may be assumed in one or more embodiments that there is not data or signal communication between vehicle 12, battery 14, BMS 16, and charger 20, the embodiments described herein are equally applicable to vehicles 12 where there is at least some data/signal communication between vehicle 12, battery 14, BMS 16, and charger 20 and/or any other device.

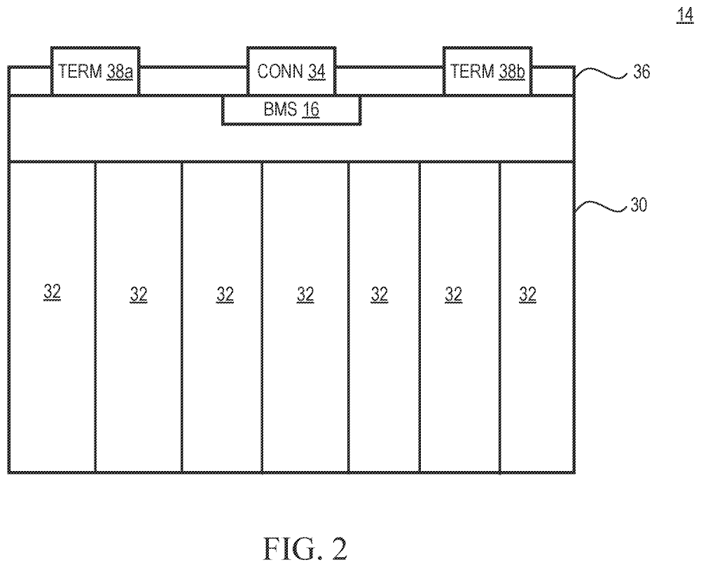

FIG. 2 shows an example battery 14 constructed in accordance with the principles of the present disclosure. Battery 14 includes a housing 30 into which one or more cells 32 are positioned. The cells 32 may be electrically interconnected (not shown in the FIGS.), such as via an electrically conductive bus bar system which electrically interconnects the cells 32 in an electrically serial, electrically parallel or combination of electrically serial and parallel manner, depending on the intended voltage and current requirements.

A battery monitoring system (BMS) 16 may be included. BMS 16 may include a monitoring connector 34 that allows for an external connection to the vehicle's data bus, or to some other communication device such as charger 20. The monitoring connector 34 can, in some embodiments, be integrated with the housing 30, such as in a cover 36 of the housing 30. Battery 14 also includes terminals, such as a positive terminal 38a and a negative terminal 38b (collectively referred to as terminals 38) to provide the contact points for electrical connection of the battery 14 (e.g., to charger 20 such as for charging and/or measuring parameters of battery 14, to the vehicle 12 to provide the auxiliary power to the vehicle and/or BMS 16 to power BMS 16 (and/or for charging/discharging functions)). Terminals 38 may be arranged to protrude through housing 30, such as protruding through cover 36. Terminals 38 may be electrically connected to the bus bars inside housing 30 and/or directly connected to the cells 32 (bus bars and direct connection not shown). In some embodiments, housing 30 includes one or more vent holes to allow venting from one or more of the cells 32.

Further, battery 14 may be arranged to provide many power capacities and physical sizes, and to operate under various parameters and parameter ranges. It is also noted that implementations of battery 14 some can be scaled to provide various capacities. For example, in some embodiments, the power capacity of battery 14 can range from 25 Ah to 75 Ah. It is noted, however, that this is range is merely an example, and that it is contemplated that embodiments of battery 14 can be arranged to provide less than a 25 Ah capacity or more than a 75 Ah capacity. Power capacity scaling can be accomplished, for example, by using higher or lower power capacity cells 32 in the housing 21, and/or by using fewer or more cells 32 in the housing 30. In some embodiments, battery 14 may be incorporated as part of a vehicle such as an electric vehicle (EV) or another type of vehicle where battery power is needed. Other electrical parameters of the battery 14 can be adjusted/accommodated by using cells 32 that may cumulatively have the desired operational characteristics, e.g., voltage, charging capacity/rate, discharge rate, etc. Thermal properties can be managed based on cell 32 characteristics, the use of heat sinks and/or thermal energy discharge plates, etc., within or external to the housing 30.

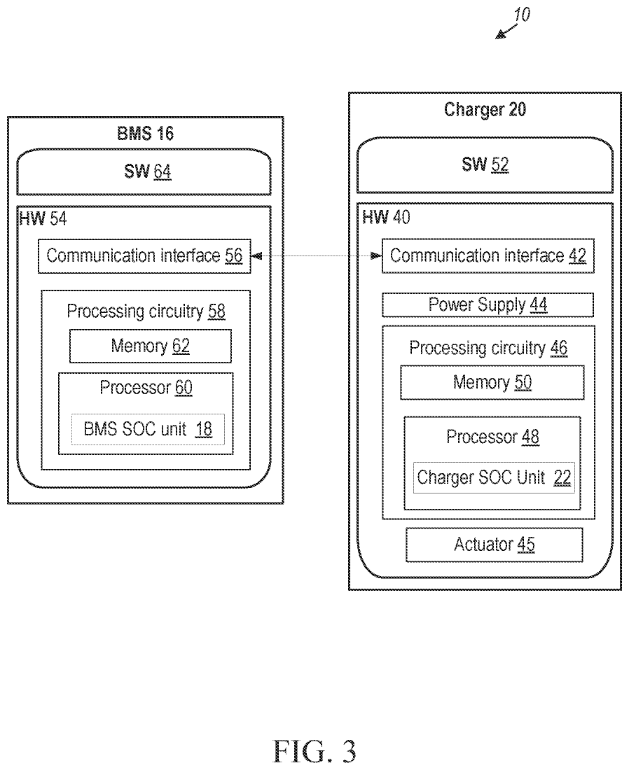

Example implementations, in accordance with an embodiment, of BMS 16 and charger 20 discussed in the preceding paragraphs will now be described with reference to FIG. 3. More specifically, system 10 includes charger 20 already referred to where charger 20 may be separate from vehicle 12 and/or be removably connectable/connected to the battery 14. Charger 20 may have hardware 40 that may include a communication interface 42 that is configured to communicate with one or more entities (e.g., BMS 16) in system 10 via wired and/or wireless communication link. The communication may be protocol based communications. Charger 20 includes a power supply 44 that is configured to provide power, energy, etc. to battery 14 via one or more power communications links (e.g., wired and/or wireless power transfer) and/or electrical connection to battery terminals 38 and/or cells 32 such as to charge battery 14 to a dynamically or preconfigured SOC level/threshold as described herein. Charger 20 may further include actuator 45 configured to accept user input and/or trigger and/or request a switch in charging mode and/or perform any other function such as the functions of charger SOC unit 22. In some embodiments, actuator 45 may be a depressible button that actuates the trigger/switch.

The hardware 40 includes processing circuitry 46. The processing circuitry 46 may include a processor 48 and memory 50. In particular, in addition to or instead of a processor, such as a central processing unit, and memory, the processing circuitry 46 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 48 may be configured to access (e.g., write to and/or read from) memory 50, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the charger 20 may further comprise software 52, which is stored in, for example, memory 50, or stored in external memory (e.g., database, etc.) accessible by the charger 20. The software 52 may be executable by the processing circuitry 46.

The processing circuitry 46 may be configured to control any of the methods and/or processes described herein and/or to cause such methods, and/or processes to be performed, e.g., by charger 20. The processor 48 corresponds to one or more processors 48 for performing charger 20 functions described herein. The charger 20 includes memory 50 that is configured to store data, programmatic software code and/or other information described herein. In some embodiments, the software 52 may include instructions that, when executed by the processor 48 and/or processing circuitry 46, causes the processor 48 and/or processing circuitry 46 to perform the processes described herein with respect to charger 20. For example, the processing circuitry 46 of the charger 20 may include charger SOC unit 22 that is configured to perform any step and/or task and/or process and/or method and/or feature described in the present disclosure, e.g., to perform one or more charging functions such as for charging up to a dynamically determined SOC level or threshold for charging of battery 14. While charger SOC unit 22 is illustrated as being part of charger 20, charger SOC unit 22 and associated functions described herein may be implemented in a device separate from charger 20 such as in battery 14 or another device. Charger SOC unit 22 may be an actuator 45 that allows for manual toggling of sleep/storage mode, e.g., toggling between two charging modes.

Further, system 10 may include BMS 16 already referred to. BMS 16 may have hardware 54 that may include a communication interface 56 that is configured to communicate with one or more entities in system 10 (and/or outside of system 10) via wired and/or wireless communication. The communication may be a protocol-based communication.

The hardware 54 includes processing circuitry 58. The processing circuitry 58 may include a processor 60 and memory 62. In particular, in addition to or instead of a processor, such as a central processing unit, and memory, the processing circuitry 58 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 60 may be configured to access (e.g., write to and/or read from) memory 62, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

BMS 16 may further comprise software 64, which is stored in, for example, memory 62, or stored in external memory (e.g., database, etc.) accessible by the BMS 16. The software 64 may be executable by the processing circuitry 58.

The processing circuitry 58 may be configured to control any of the methods and/or processes described herein and/or to cause such methods, and/or processes to be performed, e.g., by BMS 16. The processor 60 corresponds to one or more processors 60 for performing BMS 16 functions described herein. The BMS 16 includes memory 62 that is configured to store data, programmatic software code and/or other information described herein. In some embodiments, the software 64 may include instructions that, when executed by the processor 60 and/or processing circuitry 58, causes the processor 60 and/or processing circuitry 58 to perform the processes described herein with respect to BMS 16. For example, the processing circuitry 58 of the BMS 16 may include BMS SOC unit 18 that is configured to perform one or more BMS 16 functions such as with respect to performing one or more actions associated with charging battery 14.

Although FIGS. 1 and 3 show one or more “units” such as BMS SOC unit 18 and charger SOC unit 22 as being within a respective processor, it is contemplated that these units may be implemented such that a portion of the unit is stored in a corresponding memory within the processing circuitry. In other words, the units may be implemented in hardware, software or in a combination of hardware and software within the processing circuitry.

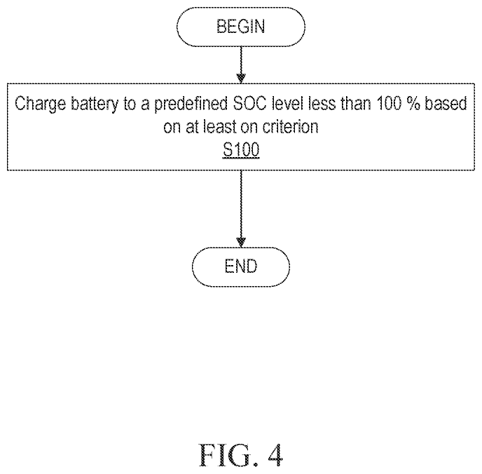

FIG. 4 is a flowchart of an example process in a charger 20 according to some embodiments of the present invention. One or more blocks described herein may be performed by one or more elements of charger 20 such as by one or more of communication interface 42, power supply 44, actuator 45, processing circuitry 46 (including the charger SOC unit 22) and/or processor 48. Charger 20 is configured to charge (Block S100) battery 14 to a predefined SOC level less than 100% based on at least one criterion.

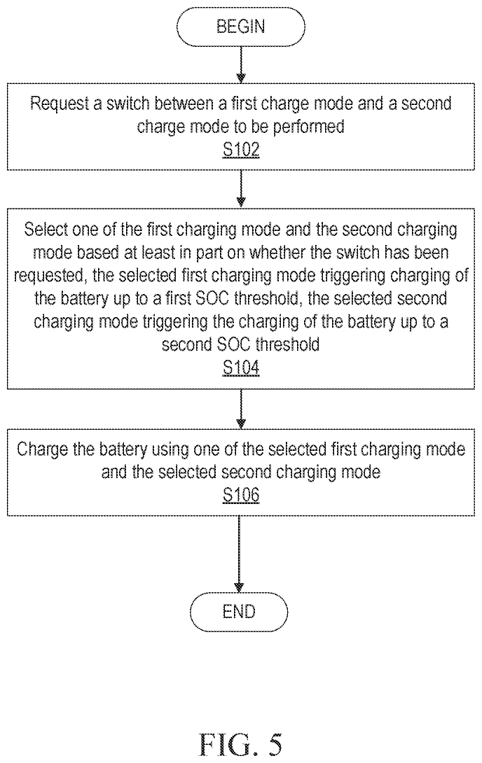

FIG. 5 is a flowchart of an example process in a charger 20 according to some embodiments of the present invention. One or more blocks described herein may be performed by one or more elements of charger 20 such as by one or more of communication interface 42, power supply 44, actuator 45, processing circuitry 46 (including the charger SOC unit 22) and/or processor 48. Charger 20 is configured to request (S102) a switch between a first charge mode and a second charge mode to be performed; select one of the first charging mode and the second charging mode based at least in part on whether the switch has been requested, where the selected first charging mode triggers charging of the battery 14 up to a first SOC threshold, and the selected second charging mode triggers the charging of the battery 14 up to a second SOC threshold; and charging the battery using one of the selected first charging mode and the selected second charging mode.

In some embodiments, the selecting of one of the first charging mode and the second charging mode includes selecting the second charging mode when the switch has been requested.

In some other embodiments, the method further includes selecting the first charging mode when at least one of the charger 20 is powered up; a predetermined interval of time has elapsed since the first charging mode was selected; when the charging of the battery 14 using the selected first charging mode is complete; and the charger 20 is disconnected from the battery.

In one embodiment, the method further includes determining at least one parameter associated with the battery 14, where the one of the first charging mode and the second charging mode are selected further based on the determined at least one parameter.

In another embodiment, the at least one parameter is determined by measuring the at least one parameter using an electrical connection to battery terminals 38.

In some embodiments, the method further includes receiving the at least one parameter (e.g., from BMS 16, from communication interface 56).

In some other embodiments, the at least one parameter is an SOC of the battery 14.

In an embodiment, triggering the charging of the battery 14 up to the first SOC threshold includes determining that the SOC is less than the first SOC threshold; triggering the charging of the battery 14 to increase the SOC up to the first SOC threshold; and/or triggering the charging of the battery 14 up to the second SOC threshold includes determining that the SOC is less than the second SOC threshold; and triggering the charging of the battery 14 to increase the SOC up to the second SOC threshold.

Having described the general process flow of arrangements of the disclosure and having provided examples of hardware and software arrangements for implementing the processes and functions of the disclosure, the sections below provide details and examples of arrangements for one or more process related to battery charging in a system 10. One or more BMS 16 functions described below may be performed by one or more of processing circuitry 58, processor 60, BMS SOC unit 18, etc. One or more charger 20 functions described below may be performed by one or more of processing circuitry 46, processor 48, charger SOC unit 22, etc. Alternatively, at least one of BMS SOC unit 18 and charger SOC unit 22 functionality may be implemented in a device or battery 14 separate from BMS 16 and charger 20, respectively.

In one or more embodiments, a method is described. The method includes performing one or more steps (e.g., switching charging modes) based on a parameter/criterion associated with system 10 and/or battery 14. For example, the method may include performing one or more steps based on a parameter threshold such as a SOC threshold. That is, battery 14 may be charged based on one or more charging modes based on a parameter threshold. In one example, battery 14 may be charged, using a default charging mode, to less than 100% SOC. In another example, battery 14 may be charged, using another charging mode other than the default mode, e.g., up to 100% SOC. The charging mode may be triggered and/or selected by pressing actuator 45. Pressing actuator 45 may toggle between charging modes. Charger 20 may perform one or more actions based on a parameter measured by BMS 16 and communicated to charger 20 using communication interfaces 42, 56.

It is generally considered good battery design to prioritize one or more actions, e.g., for the system 10 to first prioritize protection of itself and the cells 32 of battery 14. This may be executed by the charger 20 performing charging of battery 14 using a first charging mode, e.g., to an SOC that is less than 100% SOC and/or allowing a user to override the first charging mode by pressing actuator 45 to charge battery 14 based on the second charging mode up to 100% SOC.

In one or more embodiments, BMS 16 is configured to trigger charging battery 14, such as via charger 20, using the one or more charging methos, described herein.

In some embodiments, a battery/charger system (i.e., charger 20) which by default or configuration may charge the battery to a SOC less than 100% (i.e., to a first predefined or dynamically determined SOC level/threshold), such as with the purpose of improving the overall cycle life of the cells of battery 14 over existing system. The default SOC may be determined to maximize life, while still providing enough power delivery capability to perform the task which is intended (e.g., automotive starting lighting and igniting (SLI)). But, if the application demands it, a actuator 45 such as “ready to ride” actuator on the battery 14 and/or charger 20 may trigger charger 20 to charge the battery 14 to 100% SOC, thereby enabling the user/application to utilize the full energy storage capability of the battery system when charging is complete. In one or more embodiments, the first predefined or dynamically determined SOC level/threshold may be 80% or other percentage less than 100%. Hence, charger 20 allows for maximizing lithium battery cycle life by reducing SOC during storage, for example, where 100% is not required. In one or more embodiments, a range of different SOC levels could be used for charging.

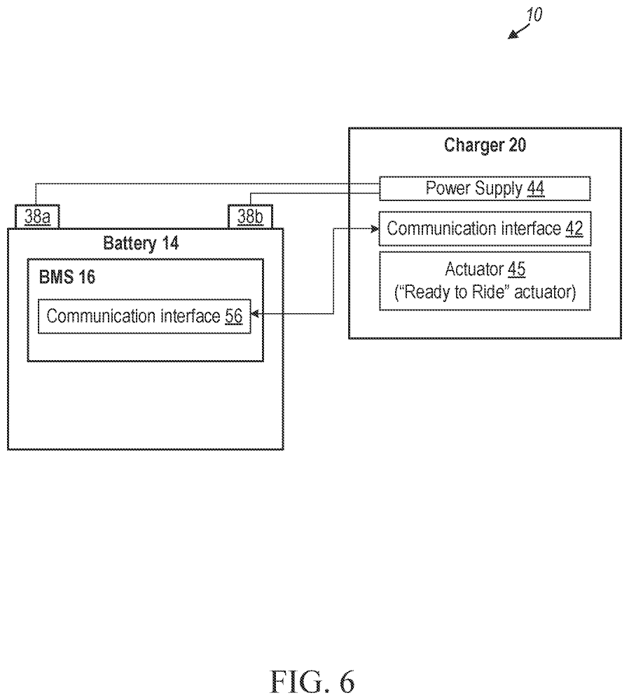

FIG. 6 shows an example charger removably connected to a battery 14 and/or BMS 16. System 10 includes charger 20 and a battery 14. Battery 14 includes BMS 16 (and/or communication interface 56) and/or first and second terminals 38a, 38b. Charger 20 includes communication interface 42, power supply 44, and actuator 45 (e.g., “ready to ride” actuator). The power supply 44 is removably connected to the first terminal 38a and the second terminal 38b of battery 14 such as to charge battery 14 (e.g., using a first charging mode and/or a second charging mode). Communication interface 42 of charger 20 is configured to receive one or more parameters from communication interface 56 of BMS 16. A parameter may be state of charge (SOC) of battery 14. The parameter (e.g., SOC) may also be measured by charger 20 using a removable electrical connection to the first and second terminals 38a, 38b. In a nonlimiting example, a user of charger 20 may want to charge battery 14 using a first charging mode. The first charging mode may be a default charging mode, where when charger 20 is powered up, charger 20 defaults to the first charging mode. The first charging mode of this nonlimiting example triggers the power supply 44 to charge the battery 14 up to a first SOC threshold, e.g., 80%, such as to promote longer battery life. Actuator 45 (e.g., “Ready to Ride” actuator, “Ready to Ride” button, etc.) is configured to receive user input to change from the first charging mode to a second charging mode. The second charging mode triggers the power supply 44 to charge the battery 14 up to a second SOC threshold, e.g., 100%, such as in the case where the user wants a vehicle 12 (e.g., electric vehicle) to have a longer range when its battery 14 is charged to full capacity. Further, the first and second charging modes may be selectable/determinable based on one or more parameters associated with the battery, which may be measured by charger 20 (e.g., via terminals 38) and/or received from BMS 16.

In one or more embodiments, several mechanisms other than actuator 45 (e.g., a physical actuator or switch), including wireless/BLUETOOTH and/or control signal from BMS 16 could be used to activate one or more charging modes such as the second charging mode (100% SOC mode). In one or more embodiments, timers, triggers via calendar events or other automated methods could be used to activate/select one or more charging modes (e.g., the 100% SOC function) such as via charger 20.

Further, although the embodiments describe the at least one parameter as a SOC, the parameter(s) are not limited as such and may include any parameter of the battery such as voltage, current, discharge rate, charge rate, temperature, etc.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings and the following claims.

1. A charger configured for charging a battery, the charger being removably connectable to the battery and comprising an actuator, a power supply, and processing circuitry in communication with the actuator and the power supply:
the actuator being configured to:
request a switch between a first charge mode and a second charge mode to be performed;
the processing circuitry being configured to:
select one of the first charging mode and the second charging mode based at least in part on whether the switch has been requested, the selected first charging mode triggering the power supply to charge the battery up to a first SOC threshold, the selected second charging mode triggering the power supply to charge the battery up to a second SOC threshold; and
the power supply being electrically and removably connectable to the battery and configured to:
charge the battery using one of the selected first charging mode and the selected second charging mode.

2. The charger of claim 1, wherein the selecting of one of the first charging mode and the second charging mode includes:
selecting the second charging mode when the switch has been requested.

3. The charger of claim 1,
wherein the processing circuitry is further configured to:
select the first charging mode when at least one of:
the charger is powered up;
a predetermined interval of time has elapsed since the first charging mode was selected;
when the charging of the battery using the selected first charging mode is complete; and
the charger is disconnected from the battery.

4. The charger of claim 1, wherein the processing circuitry is further configured to:
determine at least one parameter associated with the battery, the one of the first charging mode and the second charging mode being selected further based on the determined at least one parameter.

5. The charger of claim 4, wherein the at least one parameter is determined by measuring the at least one parameter using a removable electrical connection to battery terminals.

6. The charger of claim 4, wherein the charger further includes a communication interface configured to:
receive the at least one parameter.

7. The charger of claim 4, wherein the at least one parameter is an SOC of the battery.

8. The charger of claim 7, wherein triggering the power supply to charge the battery up to the first SOC threshold includes:
determining that the SOC is less than the first SOC threshold; and
triggering the power supply to charge the battery to increase the SOC up to the first SOC threshold.

9. The charger of claim 7, wherein triggering the power supply to charge the battery up to the second SOC threshold includes:
determining that the SOC is less than the second SOC threshold; and
triggering the power supply to charge the battery to increase the SOC up to the second SOC threshold.

10. The charger of claim 1, wherein the first SOC threshold is less than the second SOC threshold.

11. A method in a charger configured for charging a battery, the charger being removably connectable to the battery, the method comprising:
requesting a switch between a first charge mode and a second charge mode to be performed;
selecting one of the first charging mode and the second charging mode based at least in part on whether the switch has been requested, the selected first charging mode triggering charging of the battery up to a first SOC threshold, the selected second charging mode triggering the charging of the battery up to a second SOC threshold; and
charging the battery using one of the selected first charging mode and the selected second charging mode.

12. The method of claim 11, wherein the selecting of one of the first charging mode and the second charging mode includes:
selecting the second charging mode when the switch has been requested.

13. The method of a claim 11,
wherein the method further includes:
selecting the first charging mode when at least one of:
the charger is powered up;
a predetermined interval of time has elapsed since the first charging mode was selected;
when the charging of the battery using the selected first charging mode is complete; and
the charger is disconnected from the battery.

14. The method of claim 11, wherein the method further includes:
determining at least one parameter associated with the battery, the one of the first charging mode and the second charging mode being selected further based on the determined at least one parameter.

15. The method of claim 14, wherein the at least one parameter is determined by measuring the at least one parameter using a removable electrical connection to battery terminals.

16. The method of claim 14, wherein the method further includes:
receiving the at least one parameter.

17. The method of claim 14, wherein the at least one parameter is an SOC of the battery.

18. The method of claim 17, wherein at least one of:
triggering the charging of the battery up to the first SOC threshold includes:
determining that the SOC is less than the first SOC threshold;
triggering the charging of the battery to increase the SOC up to the first SOC threshold;
triggering the charging of the battery up to the second SOC threshold includes:
determining that the SOC is less than the second SOC threshold; and
triggering the charging of the battery to increase the SOC up to the second SOC threshold.

19. A system comprising:
a battery comprising a first terminal and as second terminal;
a charger being configured for charging the battery and being removably connectable to the battery, the charger comprising an actuator, a power supply, and processing circuitry in communication with the actuator and the power supply:
the actuator being configured to:
request a switch between a first charge mode and a second charge mode to be performed;
the processing circuitry being configured to:
select one of the first charging mode and the second charging mode based at least in part on whether the switch has been requested, the selected first charging mode triggering the power supply to charge the battery up to a first SOC threshold, the selected second charging mode triggering the power supply to charge the battery up to a second SOC threshold; and
the power supply being electrically and removably connectable to the first and second terminals of the battery and configured to:
charge the battery using one of the selected first charging mode and the selected second charging mode.

20. The system of claim 19, wherein at least one of:
the processing circuitry is further configured to:
determine at least one parameter associated with the battery;
the charger further includes a first communication interface configured to:
receive the at least one parameter;
the battery further includes a second communication interface configured to:
transmit the at least one parameter; and
the one of the first charging mode and the second charging mode is selected further based on one of the determined at least one parameter and the received at least one parameter.
